(19) United States
(12) Patent Application Publication
(10) Pub. No.: US 2019/0381749 A1
(43) Pub. Date: Dec. 19, 2019

(54) TWO PIECE BONDED VEHICLE COMPONENTS FORMED BY SHEET MOLDING COMPOUND-RESIN TRANSFER MOLDING ASSEMBLIES

(71) Applicant: Continental Structural Plastics, Inc., Auburn Hills, MI (US)

(72) Inventors: Probir Kumar GUHA, Bloomfield Hills, MI (US); Philippe BONTE, Pouance (FR); Marc-Philippe TOITGANS, Pouance (FR); Dominique BOYER, Pouance (FR)

(21) Appl. No.: 16/464,646

(22) PCT Filed: Nov. 29, 2017
(86) PCT No.: PCT/US2017/063723

§ 371 Date: May 28, 2019

Related U.S. Application Data
(60) Provisional application No. 62/427,890, filed on Nov. 30, 2016.

(51) Int. Cl. B29C 70/08; B29C 70/02; B29C 70/12; B29C 70/48; B29C 70/68

(52) U.S. Cl. CPC B29C 70/08; B29C 70/025; B29C 70/68; B29C 70/48; B29C 70/12

(57) ABSTRACT

A vehicle component including a first cured outer layer of a molding composition having hollow glass microspheres and a predominant fiber filler of chopped glass fibers; a second cured inner layer of molding composition having a predominant fiber filler chopped carbon fibers in an epoxy matrix; and a bonding agent with elongation properties configured to accommodate the differential coefficients of linear thermal expansion between the first cured outer layer and the second cured inner layer.

### CROSS REFERENCE TO RELATED APPLICATIONS

This application claims priority to U.S. Provisional Application No. 62/427,890 filed Nov. 30, 2016, the contents of which is incorporated herein by reference as if explicitly and fully expressed herein.

### FIELD OF THE INVENTION

The present invention in general relates to vehicle construction and in particular, to two-piece vehicle components formed with at least two layers: one of the layers an outer panel with an automotive exterior panel high gloss surface finish formed of sheet molding compound (SMC) reinforced predominantly with chopped and dispersed glass fibers, as well as other fiber types and containing glass microspheres for further weight reduction, and a second layer predominantly reinforced with carbon fibers, or a mixture of carbon, glass, and natural fibers held in an epoxy matrix formed by resin transfer molding (RTM), the separate layers being joined after resin cure to form the component.

### BACKGROUND OF THE INVENTION

The use of fiber inclusions to strengthen a matrix is well known to the art. Well established mechanisms for the strengthening of a matrix include slowing and elongating the path of crack propagation through the matrix, as well as energy distribution associated with pulling a fiber free from the surrounding matrix material. In the context of sheet molding composition (SMC) formulations, bulk molding composition (BMC) formulations, and resin transfer molding (RTM) fiber strengthening has traditionally involved usage of chopped glass fibers. There is a growing appreciation in the field of molding compositions that replacing in part, or all of the glass fiber in molding compositions with carbon fiber can provide improved component properties; however, technical problems remain that include disparate layer joinder, fiber flow, fiber surface energies, and surface quality of the resultant component.

The use of carbon fibers in composites, sheet molding compositions, and resin transfer molding (RTM) results in formed components with a lower weight as compared to glass fiber reinforced materials. The weight savings achieved with carbon fiber reinforcement stems from the fact that carbon has a lower density than glass and produces stronger and stiffer parts at a given thickness.

Weight savings in the auto, transportation, and logistics based industries has been a major focus in order to make more fuel efficient vehicles both for ground and air transport. Weight savings using carbon reinforced composites in vehicle parts has helped these industries achieve meaningful weight savings. However, high quality surface finishes, such as an automotive exterior panel high gloss surface in the auto industry that is characterized by a high surface sheen, are generally obtained only with highly tailored resin formulations that contain glass fibers, such as TCA® and TCA ULTRALITE® resins commercially available from Continental Structural Plastics, Inc. used in SMC or RTM, or metals such as aluminum and alloys thereof. High gloss surfaces are generally required for vehicle surface panels: doors, hoods, quarter panels, trunks, roof structures, bumpers, etc., which make up a significant amount of weight in a vehicle.

Furthermore, in the continuum of processes to lighten vehicle body panels, steel thickness was reduced and then supplanted with lower density materials such as aluminum and resin based materials. Evidence is developing that aluminum has several limitations that favor resin based vehicle body articles. It now appears that the material costs, forming costs and the tensile strength of aluminum at the thicknesses needed to achieve ever lighter body panels create a collective limitation. In contrast, resin based articles can be tailored by changes in resin chemistry and additives to meet a range of requirements. Additionally, while metal forming of complex shapes requires several steps, a well-designed mold can impart complex shapes in a single step.

U.S. Pat. No. 7,465,764 to Adzima et al. discloses a sizing composition containing an epoxy resin emulsion, one or more coupling agents, a cationic lubricant, and an acid. The epoxy resin emulsion includes a low molecular weight epoxy and one or more surfactants. The epoxy resin has an epoxy equivalent weight of from 175-225, preferably from 175-190. Optionally, the sizing composition may also contain a non-ionic lubricant, a polyurethane film former, and/or an antistatic agent. The sizing composition may be used to size glass fibers used in filament winding applications to form reinforced composite articles with improved mechanical properties, wet tensile properties, improved resistance to cracking, and improved processing characteristics.

Thus, there exists a need for a process and design to utilize carbon reinforced parts for vehicle surface panels.

### SUMMARY

An inventive vehicle component is provided and includes a first cured outer layer of a molding composition having hollow glass microspheres and a predominant fiber filler of chopped glass fibers; a second cured inner layer of molding composition having a predominant fiber filler chopped carbon fibers in an epoxy matrix; and a bonding agent with elongation properties configured to accommodate the differential coefficients of linear thermal expansion between the first cured outer layer and the second cured inner layer.

### BRIEF DESCRIPTION OF THE DRAWINGS

The present invention is further detailed with respect to the following drawings that are intended to show certain aspects of the present invention, but should not be construed as a limit on the practice of the present invention.

FIGS. 1A-1C are perspective views of a two-piece vehicle hood with an outer layer of glass fiber reinforced automotive exterior panel high gloss sheet material with glass microspheres, and an inner layer of an epoxy matrix formed by resin transfer molding (RTM) reinforced with carbon fiber or a combination of fibers according to embodiments of the invention;

FIG. 2 shows the vehicle hood of FIGS. 1A-1C formed with a glass fiber reinforced finished surface outer panel (see-thru surface) bonded at multiple points to a carbon fiber or hybrid fiber reinforced structural inner panel according to embodiments of the invention; and

FIG. 3 is a cross section of a typical body panel seal flange where the glass fiber based class-A outer panel is bonded (adhesive, epoxy, etc.) or secured at a bond flange of the carbon or hybrid fiber based structural inner panel according to embodiments of the invention.

### DESCRIPTION OF THE INVENTION

The present invention has utility in the formation of two-piece vehicle components that are reinforced with chopped and dispersed glass fibers in a first cured outer layer with weight reducing glass microspheres and is joined by adhesives or mechanical fasteners to a second cured layer reinforced with dispersed carbon fibers or a combination of carbon, glass, and natural fibers in a resin transfer molding (RTM) formed epoxy matrix. Embodiments of the invention have the outer layer formed using a class-A finish SMC illustratively including TCA ULTRALITE® resins commercially available from Continental Structural Plastics, Inc. as disclosed in commonly owned U.S. Patent Publication 2005/0182205, and with hollow glass microspheres as disclosed in U.S. Pat. No. 9,018,280 both of which are included herein in their entirety.

It is noted that while glass fiber predominates as a fiber filler in the first outer layer, there may be lesser amounts of carbon or natural fibers present.

Embodiments of the two piece vehicle component formed with a TCA ULTRALITE® SMC outer and carbon fiber or hybrid fiber epoxy RTM inner provides the following properties including: an assembly that is 10-15% lighter than aluminum, more cost effective than previous body part constructions, and an increased design flexibility illustratively including for decklids and liftgates.

While the present invention is detailed herein as relating to a two-piece construction, it should be appreciated that the two-piece structure described herein is readily repeated to create a multiple layer laminate. By way of example, a predominantly glass fiber filled outer skin layer is joined to opposing surfaces of a core predominantly carbon fiber filled core layer; vice versa; or a series of alternating predominantly fiber filled layers are joined with a pattern A-B-A . . . B. In certain inventive embodiments, a cured inner portion of molding composition is reinforced predominantly with chopped carbon fibers is joined to a cured outer skin of a second sheet molding composition reinforced predominantly with glass fiber, where the outer surface has an automotive surface quality finish, such as a class-A finish. As used herein, a class-A surface finish is associated with a surface shine and reflectivity required for exterior body panels by automotive manufacturers. In an embodiment, the cured inner portion is substantially devoid of glass fiber, while the outer skin is substantially devoid of chopped carbon fiber.

A surface with an automotive exterior panel high gloss is defined a panel with a Diffracto analysis D number of less than 100 when the mold platen having a Diffracto analysis D number of 25, the surface amendable to sanding, priming and paint finishing to high gloss per ASTM D 523 as measured with a glossmeter.

As used herein “molding compositions” refers to SMC, BMC and RTM resin formulations that are amenable to loading with chopped fibers of glass or carbon.

In a particular inventive embodiment, carbon fibers in a molding composition are present in an inner layer of a vehicle component containing from 10 to 40% by weight carbon fibers of the inner layer, with an outer skin layer of SMC based on the commercially available TCA® or TCA ULTRALITE® (Continental Structural Plastics, Inc.) containing glass fiber containing between 10 and 60% glass fiber by weight of the TCA® portion, as embodied in U.S. Pat. No. 7,655,297. The ratio of thickness of the inner portion to the outer skin ranges from 01-10:1. The resulting SMC inner portion layer and outer skin layer are laid out, formed, and cured separately and the two layers joined thereafter to form a component. Such a two-piece component with an inner layer containing carbon fibers is noted to have a density that is 10, 20, 30 and even 40% lower than the comparable article formed wholly from TCA® or other class-A surface finish resin. In this way, a lightweight article is formed that retains the high surface gloss of a class-A surface. It is appreciated that a given layer, can include both carbon fibers and glass fibers in combination, as well as other types of fibers such as natural cellulosic fibers that illustratively include coconut fibers with the proviso the loading of other types of fibers is limited such that glass fibers are predominantly present in a first layer and carbon fibers are predominantly present in a second layer. The predominant presence of a given type of fiber is used herein to mean that the fiber type represents more than 50% by weight of the total weight of fibers present in the layer. In certain embodiments, each layer is 100% of a given type of fiber, while in other embodiments the predominant fiber is present between 51 and 99%.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

In another inventive embodiment, carbon fibers are dispersed in a methyl methacrylate monomer based molding composition. Other suitable monomers from which a molding composition formulation is produced illustratively include unsaturated polyesters, epoxies, and combinations thereof. A molding composition formulation based on epoxy illustratively includes bis-phenol-A and Novolac based 5 epoxy terminated resins. Suitable curing agents for such an epoxy based molding composition formulation illustratively include anhydrides such as trimellitic anhydride, methyl tetrahydrophthalic anhydride (MTHPA), nadic methyl anhydride (NMA), di- and tri-functional amines, and combinations thereof.

In another inventive embodiment of the present invention, carbon fibers are dispersed in a molding composition monomer or solution containing monomer with a relative polarity of greater than 0.26, and in certain embodiments greater than 0.5, and in still other embodiments between 0.5 and 0.8. Relative polarity is defined per Christian Reichardt, “Solvents and Solvent Effects in Organic Chemistry”, Wiley-VCH, 3rd edition, 2003.

In another inventive embodiment, the carbon fibers are dispersed in molding composition formulations prior to cure resulting in a reinforced SMC, BMC or RTM cured article that has a lower density overall, and a lower percentage by weight loading of fibers, as compared to a like-layer formed with glass fiber reinforcement. Additionally, through the use of coupling agents superior tensile strength is achieved.

In certain inventive embodiments, heat is applied under suitable atmospheric conditions to remove any sizing or other conventional surface coatings on the surface of the carbon fibers prior to contact with a molding composition that upon cure forms a matrix containing the carbon fibers. In still other inventive embodiments heat is applied under an inert or reducing atmosphere to promote pyrolysis of the sizing from the core carbon fibers. It is appreciated that recycled carbon fiber is operative in an inventive two-piece vehicle component.

As carbon dissipates heat much better than glass as known from the respective coefficients of linear thermal expansion (CLTE), a predominantly carbon fiber filled layer cools more quickly than an otherwise like layer predominantly glass fiber filled. This difference in dynamic cooling after cure is compounded for thinner carbon fiber filled layers making them especially prone to warpage. Therefore, due to the differences in CTLE and material stiffness between the predominantly glass fiber filled layer and predominantly carbon filled layer, joining bonding agents must have exceptional elongation ability to compensate for the differential CTLE of the joined layers over the temperature range of −40 to 140° F. (−40 to 60° C.), and even as high as 400° F. (205° C.) associated with cure conditions and hot joinder of layers. In specific inventive embodiments, elastomeric bonding agents may be used to bond the inner layer to the outer layer. Elastomeric bonding agents operative herein to join disparate layers of an inventive component illustratively include urethanes, epoxies, and a combination thereof. In certain inventive embodiments, the bonding flange thickness is increased from ¼-½ inch (0.63-1.27 cm) for joining like fiber filler layers together to 1-1.5 inches (2.54-3.81 cm) for the inventive two-piece construction.

Preferably, the microspheroids used in the outer first layer have a mean diameter of between 12 and 45 microns. Most preferably, the microspheroids have an outer dimension of between 16 and 35 microns. Typically, microspheroids are loaded into a base SMC or BMC class-A formulation from 2 to 12 total weight percent of the resulting formulation. Preferably, the microspheroids are present from 4 to 6 total weight percent of the resulting SMC or BMC formulation. The specific amount of microspheroids added into a given molding composition formulation is dependent on factors including desired article density, microspheroid size dispersion and mean particle dimension, required article strength, required article shrinkage, and required article surface smoothness.

In a particularly preferred embodiment of the present invention, the microspheroids are pretreated with a surface coating adherent to the microspheroid surface.

A microspheroid surface is readily derivatized to bond to a surrounding resin matrix during cure. The resulting article exhibits improved physical properties.

One type of surface derivative for a microspheroid is a heteroatom functionally terminated thermoplastic coating. The heteroatom containing terminus illustratively includes a tertiary amine-, hydroxyl-, imine- or cyano-moiety. It is appreciated that such moieties under appropriate cure conditions known to the art are able to react with matrix resin components during cure to further strengthen a cured article. Tertiary amine terminated thermoplastic are readily prepared. D. H. Richards, D. M. Service, and M. J. Stewart, Br. Polym. J. 16, 117 (1984). A representative tertiary amine terminated thermoplastic is commercially available under the trade name ATBN 1300 X 21 from Noveon.

A surface activating agent that bonds to a glass microspheroid is an alkoxysilane where the silane is reactive with the silica surface of the microspheroid. Representative alkoxysilane surface activating agents for the microspheroid illustratively include:

3-aminopropyltrimethoxysilane, 3-aminopropyltriethoxysilane, 3-glycidoxypropyltrimethoxysilane, 3-glycidoxypropyltriethoxysilane, (3-glycidoxypropyl) bis(trimethylsiloxy)methylsilane, (3-glycidoxypropyl)methyldiethoxysilane, (3-glycidoxypropyl) dimethylethoxysilane, (3-glycidoxypropyl)methyldimethoxysilane, methacryloxymethyltriethoxysilane, methacryloxymethyltrimethoxysilane, methacryloxypropyldimethylethoxysilane, methacryloxypropyldimethylmethoxysilane, ethacryloxypropylmethyldimethoxysilane, methacryloxypropyltriethoxysilane, methoxymethyltrimethylsilane, 3-methoxypropyltrimethoxysilane, 3-methacryloxypropyldimethylchlorosilane, methacryloxypropylmethyldichlorosilane, methacryloxypropyltrichlorosilane, 3-isocyanatopropyldimethylchlorosilane, 3-isocyanatopropyltriethoxysilane, bis(3-triethoxysilylpropyl)tetrasulfide, and combinations thereof. More preferably, the silane surface activating agent includes an ethenically unsaturated moiety that is reactive under free radical cross-linking conditions so as to covalently bond with the hollow glass microsphere to the surrounding SMC or BMC high gloss matrix.

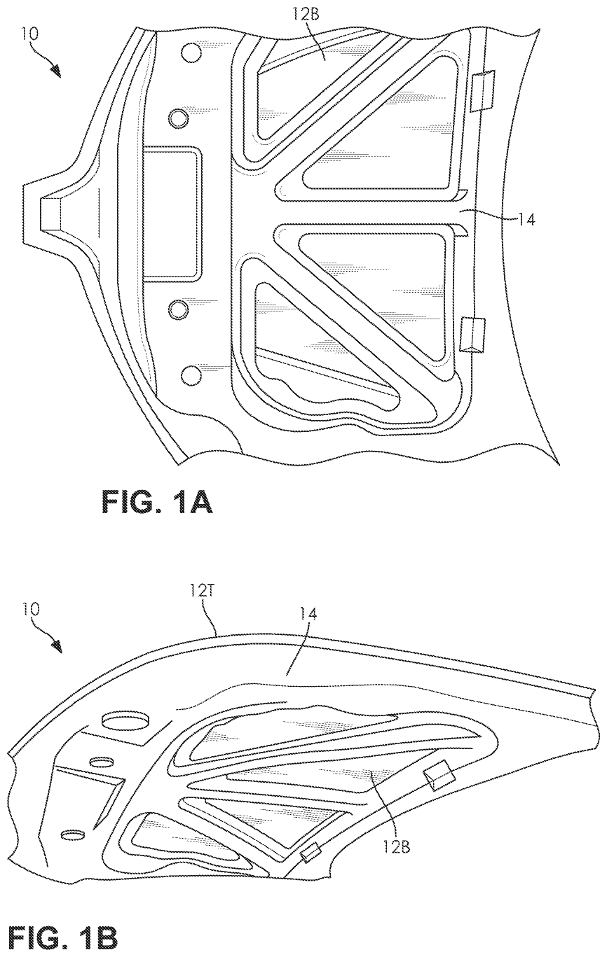

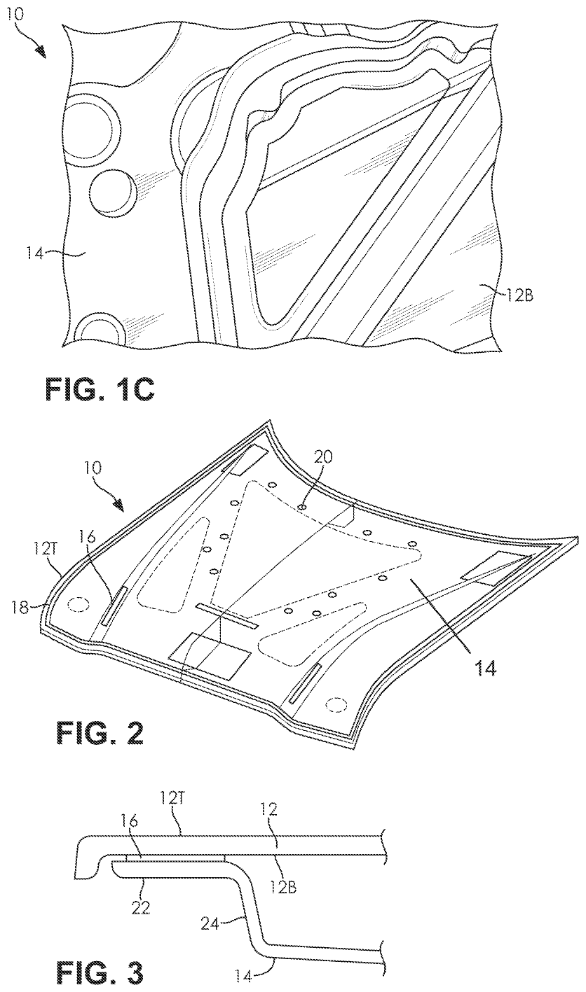

Referring now to FIGS. 1A-1C, an inventive two-piece component formed as a vehicle hood 10 is shown with an outer layer 12 of predominantly glass fiber reinforced class-A sheet material with hollow glass microspheres for additional weight reduction, and an inner layer 14 of predominantly carbon fiber reinforced sheet molding compositions. As shown, the outer layer 12 has a top portion 12T that is exposed as the outer finished surface of the vehicle, and a bottom portion 12B that is bonded to inner layer 14. The top portion 12T is amenable to sanding and painting to achieve an automotive exterior panel high gloss or similar high luster surface finish associated with a new vehicle exterior. Typical thickness of layers 12 and 14 in FIGS. 1A-1C are 2.5-2.7 millimeters (mm) and 1-2 mm, respectively. As noted above, it is appreciated that layers are joined to form more complex laminated of a cross-sectional ordering that illustratively include 12-14-12, 12-14-12-14, 12-14-(12-14)ₙ . . . 12 and 12-14-(12-14)ₙ, where n is an integer of n or more. It should also be appreciated that the thickness of layers 12 and 14 are variable depending on the desired strength and the overall laminate thickness so as to have values beyond the typical values provided above.

FIG. 2 shows the component 10 of FIG. 1 formed with a predominantly glass fiber reinforced finished surface outer layer 12 (shown as transparent for visual clarity) bonded at multiple points to a predominantly carbon fiber reinforced structural inner panel 14 according to embodiments of the invention. The inner layer 14 is bonded at various joints 16, or along a layer perimeter 18. Additionally, mastic drops 20 may provide spot adhesive bonding to modify joinder properties.

FIG. 3 is a cross section of a typical body panel seal flange where the glass fiber based automotive exterior panel high gloss outer layer 12 is bonded 16 (adhesive, epoxy) or secured at a bond flange 22 of the carbon fiber based structural inner layer 14 according to embodiments of the invention. Vehicles are generally constructed around a frame, where a vehicle has finished surface panels that are secured or bonded to substructures to form body panels that are designed for attachment to the irregular surfaces of the frame. The bond flange 22 follows a corresponding seal carrying surface. The “hat” section 24 of the structural inner panel 14 extends to reach and attach to the frame (not shown).

The foregoing description is illustrative of particular embodiments of the invention, but is not meant to be a limitation upon the practice thereof. The following claims, including all equivalents thereof, are intended to define the scope of the invention.

1. A vehicle component comprising:
a first cured outer layer of a molding composition having hollow glass microspheres and a predominant fiber filler of chopped glass fibers;
a second cured inner layer of molding composition having a predominant fiber filler chopped carbon fibers in an epoxy matrix; and
a bonding agent with elongation properties configured to accommodate the differential coefficients of linear thermal expansion between said first cured outer layer and said second cured inner layer.

2. The vehicle component of claim 1 wherein said second cured inner layer is devoid of glass fiber.

3. The vehicle component of claim 1 wherein said bonding agent is operative from −40 to 205° C.

4. The vehicle component of claim 1 wherein said bonding agent is an elastomeric adhesive.

5. The vehicle component of claim 1 further comprising a bonding flange of between 2.54-3.81 cm.

6. The vehicle component of claim 1 wherein said second cured inner layer is formed by resin transfer molding (RTM).

7. The vehicle component of claim 1 further comprising at least one additional layer of: a third cured layer of a molding composition having a predominant fiber filler chopped glass fibers and a fourth cured layer of molding composition having a predominant fiber filler chopped carbon fiber; and a second layer of bonding agent joining said at least one additional layer to one of said first outer layer or said second inner layer to form a laminate.

8. The vehicle component of claim 1 wherein at least one of said first outer cured layer or said second cured inner layer comprises a minority percentage by total fiber weight of a natural fiber.

9. The vehicle component of claim 1 wherein said first cured outer layer defines a vehicle exterior panel surface.

10. The vehicle component of claim 1 wherein said first cured outer layer forms an outer skin layer surface of a vehicle exterior panel and said second cured inner layer forms an interior layer of the vehicle exterior panel.

11. The vehicle component of claim 10 wherein the outer skin layer surface has an automotive exterior panel high gloss.

12. The vehicle component of claim 1 wherein said interior layer has an inner layer thickness and said outer skin layer has an outer skin thickness and the ratio of the inner layer thickness to outer skin thickness is between 01-10:1.

13. The vehicle component of claim 1 further comprises a paint coating.

14. The vehicle component of claim 13 wherein said first cured outer layer is substantially devoid of chopped carbon fiber.
